(19) United States
(12) Patent Application Publication
(10) Pub. No.: US 2004/0195383 A1
(43) Pub. Date: Oct. 7, 2004

(54) Intercept valve, in particular for high-pressure water guns in water-cleaning machines

(75) Inventor: Roberto Amaduzzi, Rubiera (Reggio Emilia) (IT)

Correspondence Address: YOUNG & THOMPSON, 745 SOUTH 23RD STREET 2ND FLOOR, ARLINGTON, VA, 22202

(73) Assignee: ARROW LINE S.R.L, RUBIERA (IT)

(21) Appl. No.: 10/720,099

(22) Filed: Nov. 25, 2003

(30) Foreign Application Priority Data
Feb. 26, 2003 (IT) RE2003A000022

(51) Int. Cl. B05B 7/02

(52) U.S. Cl. 239/526

(57) ABSTRACT

The intercept valve, in particular for high-pressure washing guns in water-cleaning machines, comprises a main body having a tubular conformation, an obturator arranged internally of the main body and mobile between a closed position thereof and an open position thereof, an annular seating for the obturator housed in a through-hole afforded in the main body, an activating pivot of the obturator which activating pivot is internally slidable in a through-hole afforded in the main body, means for manoeuvring which act on the activating pivot, and at least one seal arranged at the through-hole about the activating pivot and arranged adjacent to an internal mouth of the through-hole afforded in the main body.

### BACKGROUND OF THE INVENTION

Intercept valves or taps in water guns generally comprise a tubular main body internally of which there are an obturator, for example a spherical obturator, and an annular seating for the sphere. The sphere can be displaced between a closed position, in which it is in contact with the annular seating, and an open position, in which it is distanced from the annular seating, by means of an activating pivot which is internally slidable in a through-hole made in the main body. The activating pivot, which contacts at an end thereof against the obturator, is pushed at a second end thereof against an elastic action exerted by a spring which tends to keep the obturator in a contacting position against the annular seating; means for manoeuvring the pivot are what push the pivot, the means for manoeuvring being constituted by a lever pivoted to the grip of the gun, which lever is activated by the user.

To prevent infiltration of liquid towards the outside through the through-hole in which the activating pivot acts, at least one seal is included in proximity of the through-hole about the activating pivot.

In the prior art the above-mentioned seal is usually a rubber grommet, known as an O-ring, which is interpositioned between an anti-extrusion ring and a fastening ring. All of the above are housed in a cylindrical cavity of the main body arranged adjacent to the internal mouth of the through-hole.

When, as is normal, plastic materials are moulded to make the intercept valve main body, the above-described prior art exhibits numerous limitations and drawbacks, which are fundamentally connected to inevitable imperfections in the moulding of the plastic materials.

Firstly, there might be blow-holes in the main body material, i.e. cavities due to gas infiltration and material shrinkage, which are risks that are greater with thick mouldings. If the blow-holes occur in a seal zone, or appear on the surface of the cylindrical cavity in which the grommet is located, during testing a loss of fluid is immediately apparent. If, on the contrary, the blow-holes occur internally of the material, immediately below the surface of the cavity, the loss might only be revealed later. This second possibility is the more frequent and more dangerous in that it does not emerge during testing. Further, the cylindrical surface of the housing cavity of the grommet often becomes mis-shapen, with alterations caused by deformation in the plastic material during the cooling process. This defect can result in a loss of fluid or extrusion of the grommet in the play that forms between the anti-extrusion ring, the activating pivot and the main body.

It is well known that extrusion is the main cause of O-ring wear and splits in the rubber material the O-rings are made of, with a complete loss of seal functionality.

Finally, the surface finishing of the seal surfaces may present defects due to various causes, such as material scorching due to over-heated moulding, wrong moulding parameters and others besides.

### SUMMARY OF THE INVENTION

The main aim of the present invention is to provide an intercept valve which obviates the above-mentioned drawbacks.

An important aim of the invention is to provide an intercept valve which, though formed of a main body made of plastic, has a seal in proximity of the activating pivot which seal is highly operatively reliable, being practically impervious to moulding imperfections which might occur in the main body, and which limits the problem of leakage of fluid at the contact surface with the activating pivot.

The set aims and technical objectives are attained by an intercept valve, in particular for high-pressure washing guns in water-cleaner machines, which is characterised in that it comprises one or more of the technical solutions claimed in the appended claims.

### BRIEF DESCRIPTION OF THE DRAWINGS

There follows a description of a preferred and indicative but not exclusive embodiment of the intercept valve of the invention, illustrated in the accompanying figures of the drawings, in which:

FIG. 1 is a longitudinal section of a high-pressure washing gun comprising the intercept valve of the invention; and

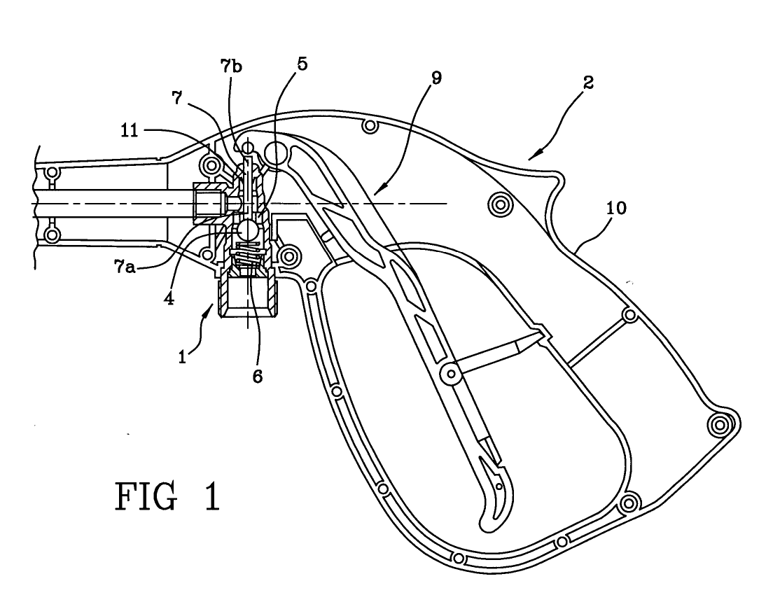

FIG. 2 is an enlarged view of a longitudinal section of the seal of the valve of FIG. 1.

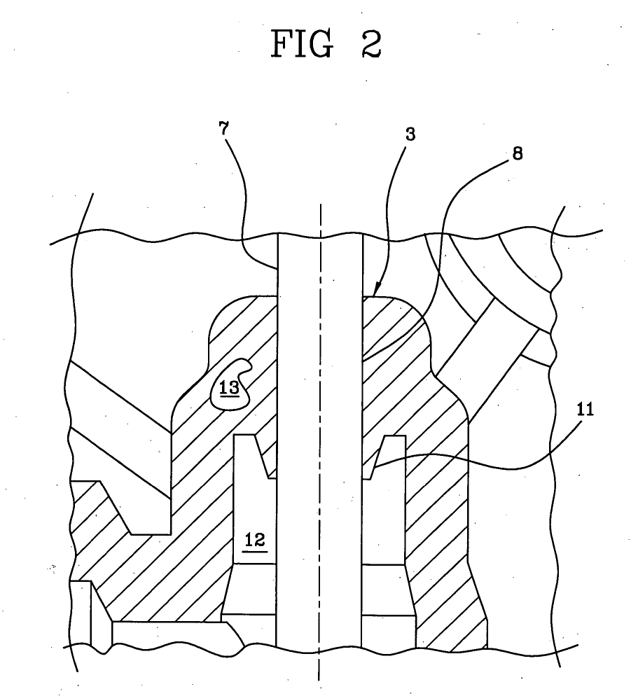

### DESCRIPTION OF THE PREFERRED EMBODIMENTS

With reference to the figures of the drawings, the intercept valve of the invention is denoted in its entirety by number 1. The intercept valve 1 can be inserted in a washing gun 2 of known and conventional type.

The intercept valve 1 comprises a main body 3 made of plastic, for example nylon strengthened with high-resistance fibre-glass. The main body 3 has a substantially tubular shape.

The tubular main body 3 internally exhibits an obturator 4, preferably spherical, an annular seating 5 for the obturator 4 and a spring 6 for elastically holding the obturator 4 in a closed position against the annular seating 5.

The obturator 4 is displaceable into an open position, in which it is detached from the annular seating 5, by means of an activating pivot 7 which is internally slidable in a through-hole 8 made in the main body 3. The activating pivot 7 exhibits a first end 7a in contact with the obturator 4 on an opposite side thereof from the spring, and a second end 7b, externally projecting with respect to the main body 3, on which means for manoeuvring 9 are active, which means for manoeuvring 9 are constituted by a lever pivoted at a grip 10 of the washing gun 2. A seal 11 developing about the activating pivot 7 is located in proximity of the through-hole 8.

The seal comprises a lip seal circumferentially contacting against the activating pivot 7 and arranged adjacent to the mouth of the through-hole 8, and facing the annular seating 5 internally of a cylindrical chamber 12 afforded in the main body 3.

The lip seal 11 is advantageously integrated in the main body 3 and is made together with the body 3 during the moulding process.

The lip seal 11 has a truncoconical shape and is of a limited thickness, and is thus very deformable. In the presence of pressurised liquid on the external surface thereof the lip seal 11 is forced against the activating pivot 7 and, thanks to the deformability thereof, prevents loss of fluid through the through-hole 8. In the absence of pressurised liquid the slight interference of the internal hole of the lip seal 11 against the external surface of the activating pivot 7 guarantees perfect functioning.

The invention offers important advantages.

First of all, any blow-holes 13 which might be produced inside the material of the main body 3 will be very unlikely to have any influence given the small thickness of the lip seal the functioning of which is therefore unaffected. Also, any deforming or alterations in shape such as, for example cuts on the surface of the internal hole of the seal are easily compensated for by the high deformability of the seal.

Further, any possible irregularities in surface finishing, for example scratches or lacerations in the internal hole of the lip seal, tend to be flattened by the pressure exerted by the fluid on the seal against the activating pivot. The activating pivot itself removes the scratches after a few translation movements in one direction or the other.

A further point is that the small transversal dimensions of the lip seal according to the invention require smaller inferior diameters of the cylindrical chamber in which the seal is housed with respect to a solution involving use of an o-ring. This reduces the moulding times and makes the intercept valve more compact and more economical to produce.

Finally, it is stressed that the lip seal integrated into the main body 3 completely eliminates any chance that there can be extrusion of the seal in the play of mobile couplings, as can happen with prior-art applications. Thus reduction of functionality due to the above cause is avoided.

The use of the lip seal of the invention leads to a considerable improvement in the reliability and working life of the seal in the intercept valve for high-pressure fluids, more than doubling working life and maintaining high-quality performance in all situations.

What is claimed:

1). An intercept valve, in particular for high-pressure washing guns in water-cleaning machines, comprising:
a main body having a tubular conformation; an obturator arranged internally of the main body and mobile between a closed position thereof and an open position thereof;
an annular seating for the obturator housed in the main body;
an activating pivot of the obturator which activating pivot is internally slidable in a through-hole afforded in the main body;
means for manoeuvring which act on the activating pivot;
at least one seal arranged at the through-hole about the activating pivot;
wherein the seal is at least one lip seal contacting against the activating pivot and arranged adjacent to an internal mouth of the through-hole afforded in the main body.

2). The intercept valve of claim 1, wherein the main body is made of a plastic material and the lip seal is integrated in the main body and is made during a moulding process of the main body.

3). The intercept valve of claim 2, wherein the lip seal has a truncoconical shape.

4). A seal for an intercept valve for high-pressure washing guns in water cleaning machines, wherein it comprises a lip seal arranged at a through hole about an activating pivot of the intercept valve; the lip seal being in contact against the activating pivot and arranged adjacent to an internal mouth of the through-hole afforded in a main body of the valve.
